(19) United States
(12) Patent Application Publication
(10) Pub. No.: US 2016/0057796 A1
(43) Pub. Date: Feb. 25, 2016

(54) METHOD AND APPARATUS FOR DISCOVERING PEER-TO-PEER DEVICES IN WI-FI COMMUNICATION SYSTEM

(71) Applicant: SAMSUNG ELECTRONICS CO., LTD., Gyeonggi-do (KR)

(72) Inventors: Jun-Hyung KIM, Gyeonggi-do (KR); Mayuresh Madhukar PATIL, Bangalore (IN); Jong-Hyo LEE, Gyeonggi-do (KR); Ji-Hye LEE, Seoul (KR); Se-Hee HAN, Seoul (KR)

(21) Appl. No.: 14/781,845

(22) PCT Filed: Mar. 31, 2014
(86) PCT No.: PCT/KR2014/002719

§ 371 Date: Oct. 1, 2015

(30) Foreign Application Priority Data
Apr. 1, 2013 (KR) 10-2013-0035360

(51) Int. Cl. H04W 76/02; H04L 29/08; H04W 8/00

(52) U.S. Cl. CPC H04W 76/023; H04W 8/005; H04L 67/104; H04W 84/12

(57) ABSTRACT

Provided is a method for discovering a device for Peer-to-Peer (P2P) communication by a first device in a Wireless Fidelity (Wi-Fi) communication system. when receiving a discovery information request from a new device, the first device determines whether there is a second device that cannot be newly connected, among currently connected devices. If there is the second device, the first device generates a discovery information response based on the second device, and sends the discovery information response to the new device.

### TECHNICAL FIELD

The present disclosure relates to a method and apparatus for discovering Peer-to-Peer (P2P) devices in a Wireless Fidelity (Wi-Fi) communication system.

### BACKGROUND ART

In a common Wi-Fi communication system, Wi-Fi devices equipped with a Wi-Fi communication module may access the Wi-Fi network through an Access Point (AP) or a router.

Recently, due to the drastic increase in data usage, the usage of Wi-Fi devices and Wi-Fi communication has also increased. Therefore, there is a need for a way to more efficiently use or enjoy Wi-Fi communication in the common Wi-Fi communication system. Accordingly, Wi-Fi P2P communication has been proposed, which allows adjacent Wi-Fi devices to directly communicate with each other without passing through an AP or a router during Wi-Fi communication in the Wi-Fi communication network.

When a device (or P2P device) supporting Wi-Fi P2P communication desires to perform P2P communication in the Wi-Fi communication network, the P2P device may generally perform a P2P discovery process and a process of forming a P2P group. The P2P group may include a plurality of P2P devices, a specific one of which may be determined as a Group Owner (GO) or a host through negotiation between the P2P devices. The host may control the other P2P devices (or clients) in the P2P group.

FIG. 1 illustrates an example of a discovery operation for P2P devices in a common Wi-Fi communication system.

Referring to FIG. 1, a host 120 and a wireless Hard Disk Drive (HDD), which is an example of a client 130 that performs Wi-Fi P2P communication under control of the host 120, are in a wireless Universal Serial Bus (USB) connected state (101). It will be assumed that, in the wireless USB connected state (101), the host 120 is performing an operation of copying files from the client 130.

In addition, it will be assumed that a new host 110 desiring to perform Wi-Fi P2P communication searches for any P2P device available in the current communication area. If the new host 110 has succeeded in discovering the existing host 120, the new host 110 may send a discovery information request to the host 120 (103). In response, the host 120 may search for P2P devices which are currently connected to the host 120. For example, it will be assumed that the host 120 has determined that the host 120 is in the wireless USB connected state (101), in which the host 120 cannot be connected to any new host since the host 120 is connected to the wireless HDD 130 on a one-to-one basis. However, the host 120 may transmit information about discovered P2P devices to the new host 110 as a P2P device information response (105) regardless of whether each of the P2P devices among the discovered P2P devices can be newly connected.

Therefore, the new host 110 may not determine whether the P2P device can be connected, even though the new host 110 receives the discovery information response. Accordingly, the new host 110 may attempt connection to the P2P device that cannot be newly connected.

The above information is presented as background information only to assist with an understanding of the present disclosure. No determination has been made, and no assertion is made, as to whether any of the above might be applicable as prior art with regard to the present disclosure.

### DISCLOSURE OF INVENTION

### Technical Problem

An aspect of the present disclosure is to address at least the above-mentioned problems and/or disadvantages and to provide at least the advantages described below. Accordingly, an aspect of the present disclosure is to provide a method and apparatus for generating discovery information based on information related to a P2P device that cannot be newly connected, and providing the discovery information to a new host.

Another aspect of the present disclosure is to provide a method and apparatus for generating discovery information that includes information about a P2P device that cannot be newly connected, and information indicating whether a new connection mapped to the P2P device is supported, and providing the discovery information to a new host.

Another aspect of the present disclosure is to provide a method and apparatus for generating discovery information that includes information about a P2P device that cannot be newly connected, and information indicating possibility of a new connection, and providing the discovery information to a new host.

### Solution to Problem

In accordance with an aspect of the present disclosure, there is provided a method for discovering a device for Peer-to-Peer (P2P) communication by a first device in a Wireless Fidelity (Wi-Fi) communication system. The method includes, upon receiving a discovery information request from a new device, determining whether there is a second device that cannot be newly connected, among currently connected devices; and generating, if there is the second device, a discovery information response based on the second device, and sending the discovery information response to the new device.

In accordance with an aspect of the present disclosure, there is provided a first device for discovering a device for P2P communication in a Wi-Fi communication system. The first device includes a transceiver configured to receive a discovery information request from a new device; and a controller configured to determine whether there is a second device that cannot be newly connected, among currently connected devices, to generate, if there is the second device, a discovery information response based on the second device, and to send the discovery information response to the new device.

Other aspects, advantages, and salient features of the disclosure will become apparent to those skilled in the art from the following detailed description, which, taken in conjunction with the annexed drawings, discloses exemplary embodiments of the disclosure.

### Advantageous Effects of Invention

As is apparent from the foregoing description, according to the first to third embodiments of the present disclosure, the host may operate to prevent the unnecessary new connection to the P2P devices which are currently connected.

The host may generate discovery information for preventing attempts to connect with the P2P device that cannot be connected, and provide the discovery information to a new host, allowing the new host not to attempt the unnecessary connection.

### BRIEF DESCRIPTION OF DRAWINGS

The above and other aspects, features and advantages of certain exemplary embodiments of the present disclosure will be more apparent from the following description taken in conjunction with the accompanying drawings, in which:

FIG. 1 illustrates an example of a discovery operation for P2P devices in a common Wi-Fi communication system;

FIG. 2 illustrates an example of a discovery operation for P2P devices in a common Wi-Fi communication system;

FIG. 3 illustrates an example of a discovery operation for P2P devices in a Wi-Fi communication system according to a first embodiment of the present disclosure;

FIG. 4 is a flow diagram illustrating an example of a discovery operation for P2P devices in a Wi-Fi communication system according to the first embodiment of the present disclosure;

FIG. 5 illustrates an example of a discovery operation for P2P devices in a Wi-Fi P2P communication system according to a second embodiment of the present disclosure;

FIG. 6 is a flow diagram illustrating an example of a discovery operation for P2P devices in a Wi-Fi P2P communication system according to the second embodiment of the present disclosure;

FIG. 7 illustrates an example of a format for service query request and response according to an embodiment of the present disclosure;

FIG. 8 illustrates an example of a discovery operation for P2P devices in a Wi-Fi communication system according to a third embodiment of the present disclosure;

FIG. 9 is a flow diagram illustrating an example of a discovery operation for P2P devices in a Wi-Fi P2P communication system according to the third embodiment of the present disclosure;

FIG. 10 is a flowchart illustrating an example of an operation of a host according to an embodiment of the present disclosure; and

FIG. 11 illustrates an example of a structure of a P2P device according to an embodiment of the present disclosure.

Throughout the drawings, like reference numerals will be understood to refer to like parts, components, and structures.

### MODE FOR THE INVENTION

The following description with reference to the accompanying drawings is provided to assist in a comprehensive understanding of exemplary embodiments of the disclosure as defined by the claims and their equivalents. It includes various specific details to assist in that understanding but these are to be regarded as merely exemplary. Accordingly, those of ordinary skilled in the art will recognize that various changes and modifications of the embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of exemplary embodiments of the present disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

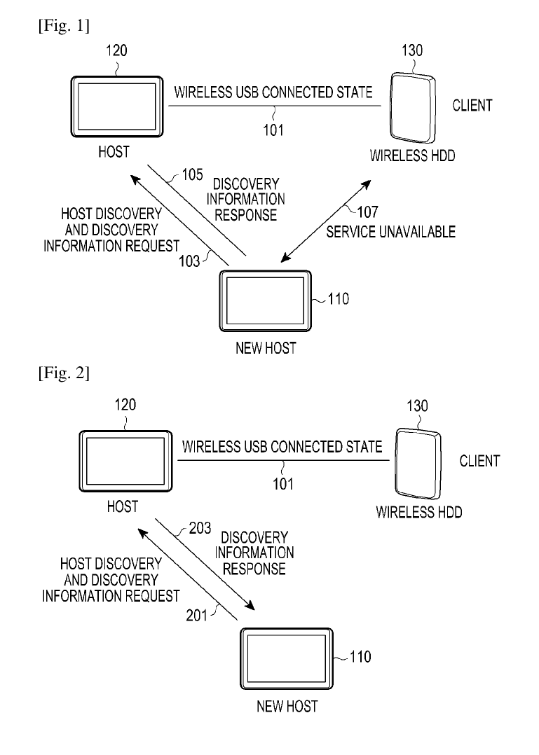

FIG. 2 illustrates an example of a discovery operation for P2P devices in a common Wi-Fi communication system. For convenience of description, it will be assumed herein that the Wi-Fi communication system is configured in the same way as that in FIG. 1.

Referring to FIG. 2, as described in FIG. 1, a host 120 is assumed to be in a wireless USB connected state (101) in which the host 120 is connected to a wireless HDD 130.

Generally, if a new host 110 desiring to perform new P2P communication discovers the existing host 120, the new host 110 may send a discovery information request to the host 120 (201).

Upon receiving the discovery information request, the host 120 may transmit information about its currently connected client to the new host 110 as a discovery information response (203). For example, it will be assumed that the client, which is currently connected to the host 120, is the wireless HDD 130 that supports one-to-one connections. Therefore, the wireless HDD 130 cannot be newly connected to the new host 110. However, the discovery information response that the host 120 provides to the new host 110 may simply include information indicating that the wireless HDD 130 is one of the discovered P2P devices, but may not include information indicating that the current state of the wireless HDD 130 is the wireless USB connected state (101). Therefore, the new host 110 may attempt impossible connection to the wireless HDD 130, information about which the new host 100 has obtained from the discovery information response (203).

Therefore, in an embodiment of the present disclosure, discovery information may be defined, based on which if a P2P device desiring to perform new P2P communication occurs, it is possible to reduce impossible connection to P2P devices which cannot be currently newly connected, among the P2P devices that can be discovered by the occurred P2P device. In addition, an embodiment of the present disclosure provides a method and apparatus for discovering P2P devices based on the discovery information.

### First Embodiment

A first embodiment of the present disclosure provides a way to generate discovery information configured to exclude information about P2P devices which cannot be currently newly connected, and to provide the discovery information to a P2P device desiring to perform new P2P communication.

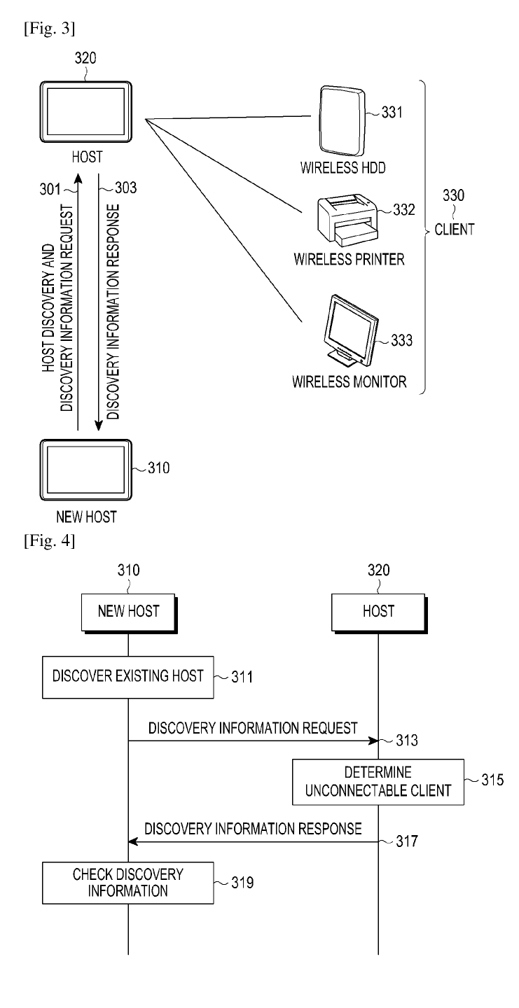

FIG. 3 illustrates an example of a discovery operation for P2P devices in a Wi-Fi communication system according to a first embodiment of the present disclosure.

Referring to FIG. 3, it will be assumed that a host 320 is currently connected to clients 330. The client 330 may include at least one of a wireless HDD 331, a wireless printer 332 and a wireless monitor 333. For example, it will be assumed herein that the host 320 is in a wireless USB connected state to the wireless HDD 331.

It will be assumed that there is a new host 310 desiring to perform new P2P communication. In this case, the new host 310 may discover the existing host 320 by performing host discovery, and send a discovery information request to the host 320 (301).

In response, the host 320 may determine P2P devices which are currently connected to the host 320. In addition, the host 320 may determine that the wireless HDD 331 cannot be newly connected to other P2P devices. Then, the host 320 according to the first embodiment of the present disclosure may send, to the new host 310 (303), a discovery information response configured to exclude information about the wireless HDD 331, in response to the request of the new host 310. The discovery information response may include information about, for example, the wireless printer 332 and the wireless monitor 333.

Then the new host 310 may not attempt unnecessary connection to the wireless HDD 331, since the new host 310 cannot recognize the presence of the wireless HDD 331 from the discovery information response.

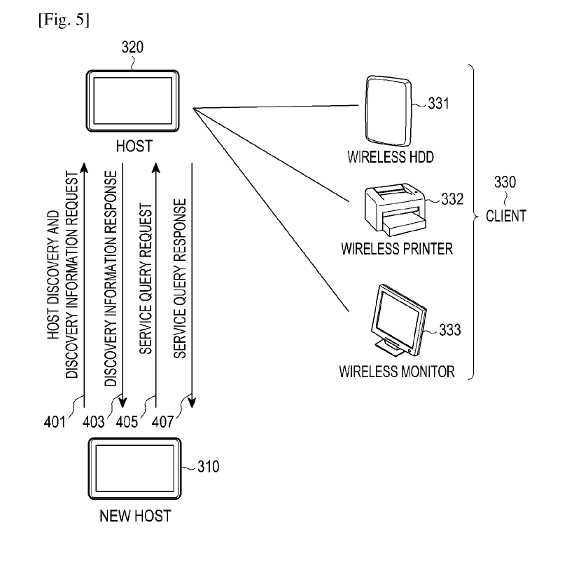

FIG. 4 is a flow diagram illustrating an example of a discovery operation for P2P devices in a Wi-Fi communication system according to the first embodiment of the present disclosure. For convenience of description, it will be assumed herein that the Wi-Fi communication system is configured in the same way as that in FIG. 3.

Referring to FIG. 4, it will be assumed that the new host 310 has occurred, which desires to perform P2P communication in the Wi-Fi communication system. In operation 311, the new host 310 may discover the existing host 320.

In operation 313, the new host 310 may send a discovery information request to the host 320. In operation 315, the host 320 may determine P2P devices which cannot be connected to another host, among the clients connected to the host 320. In operation 317, the host 320 may generate a discovery information response configured to exclude information about P2P devices (e.g., the wireless HDD 331) which cannot be currently newly connected, among the clients connected to the host 320, and send the discovery information response to the new host 310. The discovery information request and the discovery information response may be configured using, for example, probe request/response frames illustrated in Table 1, respectively. If the host 320 is assumed to be a GO of the P2P group, a probe request corresponding to the discovery information request may be configured not to include a P2P Group Info field. A probe response corresponding to the discovery information response may include the P2P Group Info field. As illustrated in Table 2, the P2P Group Info field may be configured to include a list of only the connectable P2P devices excluding the unconnectable P2P devices which are determined in operation 315.

TABLE 1

| Attributes | Attribute ID | Note |
|---|---|---|
| P2P Capabiltiy | 2 | The P2P Capabiltiy attribute shall be |
| | | present in the P2P IE. |
| Extended Listen | 8 | The Extended Listen Timing attribute |
| Timing | | may be present in the P2P IE. |
| Notice of | 12 | The Notice of Absence attribute shall |
| Absence | | only be present in the P2P IE in the |
| | | Probe Response frames transmitted by a |
| | | P2P Group Owner when a Notice of |
| | | Absence schedule is being advertised |
| | | in the Beacon frames(see §3.3.3.2). |
| P2P Device Info | 13 | The P2P Device Info attribute shall be |
| | | present in the P2P IE to indicate |
| | | the P2P Device information. |
| P2P Group Info | 14 | The P2P Group Info attribute shall only |
| | | be present in the P2P IE in the Probe |
| | | Response frame that is transmitted by |
| | | a P2P Group Owner. |

TABLE 2

| Field Name | Size(octets) | Value | Description |
|---|---|---|---|
| Attribute ID | 1 | 14 | Identifying the type of P2P |
| | | | attribute. The specific value |
| | | | is defined in Table 6. |
| Length | 2 | variable | Length of the following fields |
| | | | in the attribute. |
| P2P Client Info | Sum of all | — | List of P2P Client Info |
| Descriptor(s) | P2P Client | | Descriptor(s) for P2P Devices |
| | Info De- | | associated with this P2P Group |
| | scriptor(s) | | Owner (see Table 31). |

In operation 319, the new host 310 may obtain information about the connectable P2P devices from the received discovery information response. For example, the new host 310 may extract the P2P Group Info field from the probe response corresponding to the discovery information response. The new host 310 may not recognize the presence of the wireless HDD 331, since the P2P Group Info field does not include information ‘P2P Client Info Descriptor(s)’ about the discovered P2P devices including the wireless HDD 331. Accordingly, the new host 310 may not attempt connection to the unconnectable wireless HDD 331.

### Second Embodiment

In a second embodiment of the present disclosure, if there is at least one P2P device that cannot be currently connected, among the P2P devices that can be discovered by a new host, the existing host may send, to the new host, a discovery information response configured to include information indicating that the at least one P2P device cannot be connected.

FIG. 5 illustrates an example of a discovery operation for P2P devices in a Wi-Fi P2P communication system according to a second embodiment of the present disclosure.

Referring to FIG. 5, like in FIG. 3, the new host 310 may discover the host 320 by performing host discovery, and send a discovery information request to the discovered host 320 (401).

Upon receiving the discovery information request (401), the host 320 may determine information about the P2P devices connected to the host 320. The host 320 is assumed to be currently connected to the client 330. The client 330 may be at least one of the wireless HDD 331, the wireless printer 332, and the wireless monitor 333. For example, it will be assumed herein that the host 320 is in a wireless USB connected state to the wireless HDD 331.

Upon determining the presence of at least one P2P device (e.g., the wireless HDD 331) that cannot be newly connected, among the currently connected P2P devices, the host 320 may include or insert, in a discovery information response, a Service Query Support field indicating the current connection state for the P2P device that cannot be newly connected, and send the discovery information response to the new host 310 (403). The discovery information response (403) may include not only the information about the connectable wireless printer 332 and wireless monitor 333, but also the information about the wireless HDD 331. The discovery information response 403 according to the second embodiment of the present disclosure may be represented as shown in, for example, Table 3 below. Referring to Table 3, the discovery information response may include a Length field, a P2P Device address field, a P2P Interface address field, a Device Capability Bitmap field, a Config Methods field, a Primary Device Type field and the like.

TABLE 3

| Field Name | Size(octets) | Value | Description |
|---|---|---|---|
| Length | 1 | variable | Length of the following |
| | | | fields. |
| P2P Device | 6 | — | An identifier used to |
| address | | | uniquely reference a P2P |
| | | | Device. |
| P2P Interface | 6 | — | An address used to identify |
| address | | | a P2P Device within a |
| | | | P2P Group. |
| Device Ca- | 1 | variable | A set of parameters |
| pability | | | indicating P2P Device's |
| Bitmap | | | capabilities, as defined |
| | | | in Table 12. |
| Config | 2 | As defined | The WSC Methods that are |
| Methods | | in [6] | supported by this device |
| | | | e.g. PIN from a Keypad, |
| | | | PBC etc. Contains only |
| | | | the Data part of the WSC |
| | | | Config Methods attri- |
| | | | bute(see [6]). Note ? |
| | | | Byte ordering within the |
| | | | Config Methods field shall |
| | | | be big-endian. |
| Primary | 8 | As defined | Primary Device Type of the |
| Device Type | | in Annex B | P2P Client (see Annex B). |
| | | | Contains only the Data part |
| | | | of the WSC Primary Device |
| | | | Type attribute (excludes the |
| | | | Attribute ID and Length |
| | | | fields). Note ? Byte |
| | | | ordering within the Primary |
| | | | Device Type field shall be |
| | | | big-endian. |

In this case, the Service Query Support field may be included in the Device Capability Bitmap field as illustrated in Table 4 below. Referring to Table 4, the Device Capability Bitmap field may be set as ‘1’ to indicate that the host 320 supports the service query, using the Service Query Support field.

TABLE 4

| Bit(s) | Information | Notes |
|---|---|---|
| 0 | Service | The Service Discovery field shall be set |
| | Discovery | to 1 if the P2P device supports Service |
| | | Discovery, and is set to 0 otherwise. |
| 1 | P2P Client Dis- | Within a P2P Group Info attribute and a |
| | coverability | (Re)association request frame the P2P Client Dis- |
| | | coverability field shall be set to 1 when the P2P |
| | | Device supports P2P Client Discoverability, and |
| | | is set to 0 otherwise. This field shall be |
| | | reserved and set to 0 in all other frames or uses. |
| 2 | Concurrent | The Concurrent Operation field shall be set |
| | Operation | to 1 when the P2P Device supports Concurrent |
| | | Operation with WLAN, and is set to 0 otherwise. |
| 3 | P2P Infra- | The P2P Infrastructure Managed field shall be set |
| | structure | to 1 when the P2P interface of the P2P Device is |
| | Managed | capable of being managed by the WLAN |
| | | (infrastructure network) based on P2P Cosexis- |
| | | tence Parameters, and set to 0 otherwise. |
| 4 | P2P Device | The P2P Device Limit field shall be set to |
| | Limit | 1 when the P2P Device is unable to participate |
| | | in additional P2P Groups, and set to 0 otherwise. |
| 5 | P2P Invitaion | The P2P Invitation Procedure field shall be set |
| | Procedure | to 1 if the P2P Device is capable of processing |
| | | P2P Invitation Procedure signaling, and set |
| | | to 0 otherwise. |
| 6 | Service Query | Service Query Support shall be set |
| | Support | to 1 if the Group Owner supports service |
| | | information of a P2P Device. |
| 7 | Reserved | — |

Upon receiving the discovery information response according to the second embodiment of the present disclosure (407), the new host 310 determine whether the Service Query Support field included in the discovery information response is set as ‘1’. If it is determined that the Service Query Support field is set as ‘1’, the new host 310 may send a service query request to the host 320 (405). In response to the service query request, the host 320 may send a service query response to the new host 310 (407). For example, the service query response may be represented as shown in Table 5 below.

With the use of a specific bit of a Device Capability Bitmap field included in the service query response defined as illustrated in Table 5, it is possible to indicate that the P2P device is in a state (e.g., “USB usage”) in which the P2P device cannot be currently connected.

TABLE 5

| Bit(s) | Information | Notes |
|---|---|---|
| 0 | Service | The service discovery field shall be set to 1 |
| | Discovery | if the P2P device supports Service Discovery, |
| | | and is set to 0 otherwise. |
| 1 | P2P Client Dis- | Within a P2P Group Info attribute and a |
| | coverability | (Re)association request frame the P2P Client |
| | | Discoverability field shall be set to 1 when |
| | | the P2P Device supports P2P Client |
| | | Discoverability, and is set to 0 otherwise. |
| | | This field shall be reserved and set to |
| | | 0 in all other frames or uses. |
| 2 | Concurrent | The Concurrent Operation field shall be set to 1 |
| | Operation | when the P2P Device supports Concurrent |
| | | Operation with WLAN, and is set to 0 otherwise. |
| 3 | P2P Infra- | The P2P Infrastructure Managed field shall be set |
| | structure | to 1 when the P2P interface of the P2P Device is |
| | Managed | capable of being managed by the WLAN |
| | | (infrastructure network) based on P2P Cosexis- |
| | | tence Parameters, and set to 0 otherwise. |
| 4 | P2P Device | The P2P Device Limit field shall be set to 1 |
| | Limit | when the P2P Device is unable to participate |
| | | in additional P2P Groups, and set to 0 otherwise. |
| 5 | P2P Invitaion | The P2P Invitation Procedure field shall be |
| | Procedure | set to 1 if the P2P Device is capable of processing |
| | | P2P Invitation Procedure signaling, and set to |
| | | 0 otherwise |
| 6 | USB usage | USB usage field shall be set to 1 if the P2P |
| | | Device is connected as a USB peripheral. |
| 7 | Reserved | — |

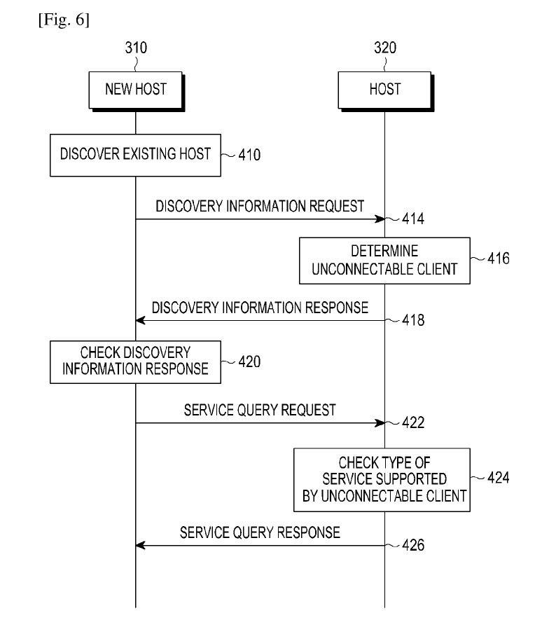

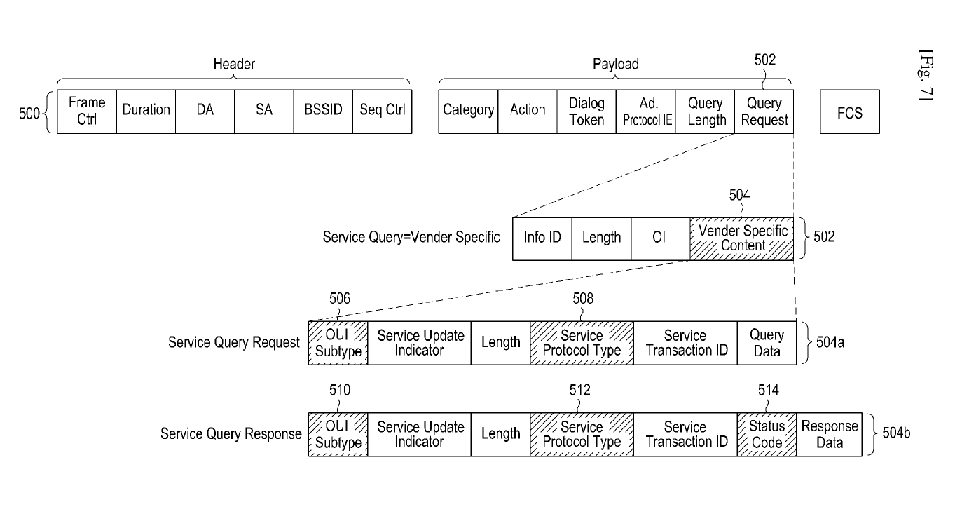

FIG. 6 is a flow diagram illustrating an example of a discovery operation for P2P devices in a Wi-Fi P2P communication system according to the second embodiment of the present disclosure. It will be assumed herein that the Wi-Fi communication system is configured in the same way as that in FIG. 5.

Referring to FIG. 6, upon discovering the existing host 320 in operation 410, the new host 310 may send a discovery information request to the host 320 in operation 414.

Upon receiving the discovery information request, the host 320 may determine in operation 416 whether there is any P2P device that cannot be newly connected to a new host, among the currently connected clients. It will be assumed that there is a P2P device that cannot be newly connected. Then, the host 320 may set a Service Query Support field in a discovery information response as ‘1’, and send the discovery information response to the new host 310 in operation 418.

In operation 420, the new host 310 may check the discovery information response. For example, if the discovery information response includes the Service Query Support field, the Service Query Support field is assumed to be set as ‘1’. Accordingly, the new host 310 may send a service query request to the host 320 in operation 422. In operation 424, the host 320 may determine the P2P device that cannot be newly connected, among the currently connected P2P devices (e.g., P2P devices currently connected to the host 320). The host 320 may generate a service query response by mapping information about the determined P2P device and state information (e.g., ‘USB usage’) indicating that the P2P device cannot be currently connected. In operation 426, the host 320 may send the service query response to the new host 310. The detailed structure of the service query request and the service query response will be described with reference to FIG. 7.

As a result, the new host 310 may determine the P2P device that cannot be currently connected, through the service query, thereby preventing the unnecessary connection to the P2P device.

FIG. 7 illustrates an example of a format for service query request and response according to an embodiment of the present disclosure.

Referring to FIG. 7, the service query request and the service query response according to the second embodiment of the present disclosure may be provided through, for example, a Generic Advertisement Service (GAS) frame structure. A GAS frame 500 may include a Header field, a Payload field, and a Frame Check Sequence (FCS) field. The service query request-related information may be included in any one (e.g., a Query Request field 502) of the fields included in the Payload field. For example, the Query Request field 502 may include an info ID field, a Length field, an Organization Identifiers (OI) field, and a Vender Specific Content field 504.

As an example, if the Vender Specific Content field 504 corresponds to the service query request, the Vender Specific Content field 504 may include an Organizationally Unique Identifier (OUI) Subtype field 506, a Service Protocol Type field 508 and the like as shown by 504a.

As another example, if the Vender Specific Content field 504 corresponds to the service query response, the Vender Specific Content field 504 may further include a Status Code field 514 in addition to an OUI subtype field 510 and a Service Protocol Type field 512, as shown by 504b. The Status Code field 514 may include ‘USB usage’ of the P2P device that cannot be currently connected. As described above, ‘USB usage’ may be provided by the service query response. For reference, if ‘USB usage’ is included in the service query response, it means that the P2P device that cannot be currently connected is in the wireless USB connected state.

### Third Embodiment

In a third embodiment of the present disclosure, if the existing host determines the presence of a P2P device that cannot be currently newly connected, after the existing host has received a discovery information request from a new host, then the existing host may provide to the new host, not only the information indicating that the at least one P2P device cannot be connected, but also the information indicating a service end time of the P2P device.

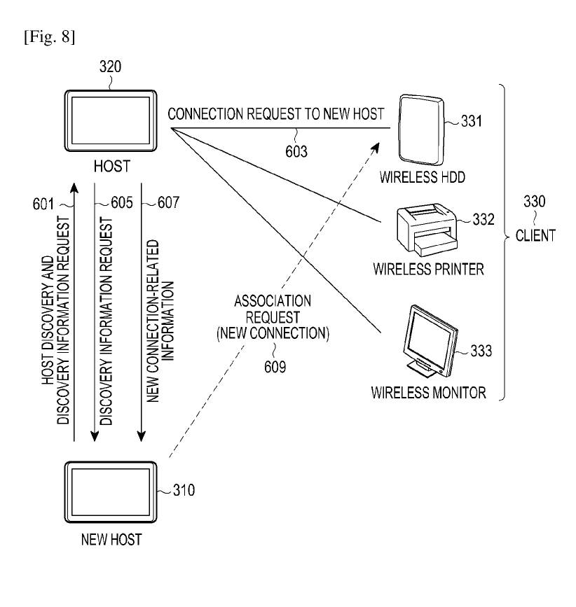

FIG. 8 illustrates an example of a discovery operation for P2P devices in a Wi-Fi communication system according to a third embodiment of the present disclosure.

Referring to FIG. 8, the new host 310 may perform host discovery, and send a discovery information request to the discovered existing host 320 (601).

Upon receiving the discovery information request, the host 320 may determine a client 330 that is currently connected to the host 320. For example, it will be assumed that the host 320 has determined that there is a P2P device that cannot be newly connected, among the clients connected to the host 320. If the host 320 determines that the host 320 is now in the wireless USB connected state to the wireless HDD 331, the host 320 may provide, to the wireless HDD 331, the information indicating occurrence of a new-connection request to the new host 310 (603). The host 320 may include or insert, in a discovery information response, information indicating the presence of the P2P device (e.g., the wireless HDD 331) that cannot be newly connected, and send the discovery information response to the new host 310 (605). In this case, as described above, the discovery information response may be sent after it is configured to include the Service Query Support field according to the second embodiment of the present disclosure. In this case, optionally, the new host 310 may include or insert, in a service query request, information about the P2P device that cannot be currently connected, and “USB usage” mapped thereto, and send the service query request to the host 320.

Thereafter, if the new host 310 requests related information for new connection to the wireless HDD 331 from the host 320, and receives the requested information (607), the new host 310 may send an association request for new connection to the wireless HDD 331 (609). When sending the association request (609), the new host 310 may set up an association for the new connection to the wireless HDD 331 directly without the new discovery process or the client authentication process, based on the related information for new connection, which was received in advance (607).

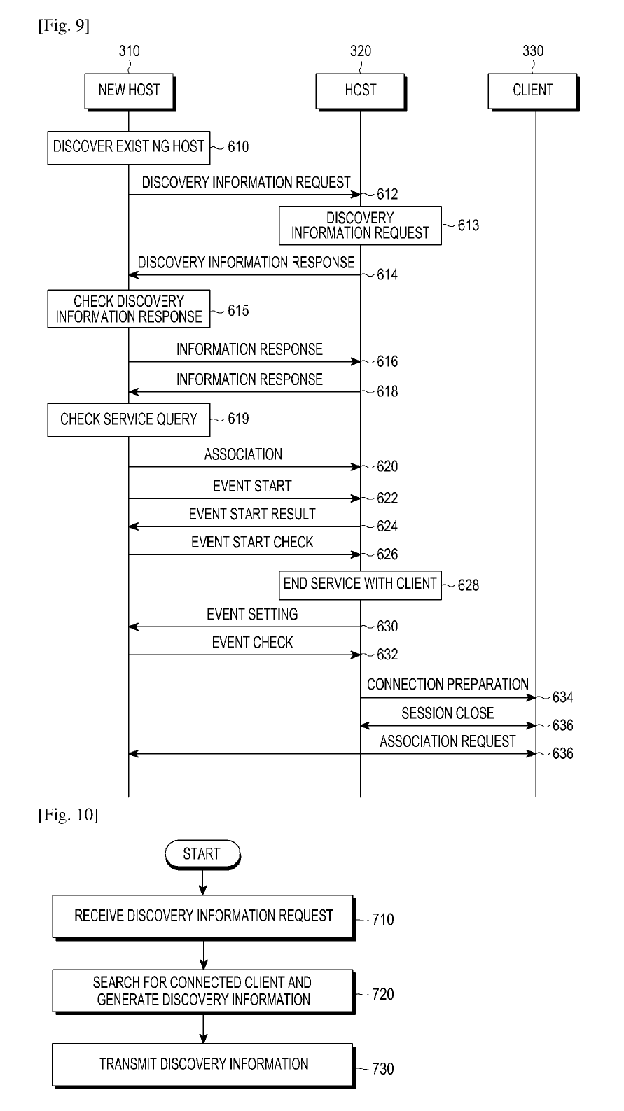

FIG. 9 is a flow diagram illustrating an example of a discovery operation for P2P devices in a Wi-Fi P2P communication system according to the third embodiment of the present disclosure. The discovery operation in FIG. 9 will be described based on the configuration in FIG. 8.

Referring to FIG. 9, the new host 310 may discover the existing host 320 in operation 610.

In operation 612, the new host 310 may send a discovery information request to the host 320.

Upon receiving the discovery information request, the host 320 may check information about the P2P device which cannot be newly connected, among the clients currently connected to the host 320, in operation 613. In operation 614, the host 320 may send, to the new host 310, a discovery information response including the information about the P2P device that cannot be newly connected. In operation 615, the new host 310 may check the discovery information response and determine whether the host 320 supports service query.

For example, if it is determined that the host 320 supports service query, the new host 310 may send a service query request to the host 320 in operation 616. In response, the host 320 may map the P2P device that cannot be currently connected, and its state information in a service query response, and send the service query response to the new host 310, in operation 618.

In operation 619, the new host 310 may check the service query response to check information about the P2P device that cannot be currently newly connected.

Thereafter, in operation 620, the new host 310 may perform association with the host 320 in order to set an event for new connection to the P2P device (e.g., the wireless HDD 331) that cannot be currently connected.

In operation 622, the new host 310 may send, to the host 320, an Event Start for requesting to inform that the connection of the client 330 is ended, when the end of the connection happens.

In operation 624, the host 320 may send an Event Start Result indicating allowance or disallowance for the event, to the new host 310 as the results for the Event Start. If the results indicate allowance, the Event Start Result may further include information about the time expected until connection to the client 330.

In operation 626, the new host 310 may send, to the host 320, an Event Start Check indicating that the new host 310 has checked the Event Start Result.

For example, if the host 320 ends its service with the client 330 in operation 628, the host 320 may send an Event Setting to the new host 310 in operation 630. The Event Setting may include information indicating that the client 330 can be currently connected, or information about the channel connectable to the client 330.

In operation 632, the new host 310 may send, to the host 320, an Event Check indicating a response that the new host 310 has checked the Event Setting. In operation 634, the host 320 may prepare a connection between the new host 310 and the client 330.

If the session between the host 320 and the client 330 is closed in operation 636, the new host 310 may send an association request to the client 330 in operation 639. In this case, the new host 310 may associate with the client 330 without separately performing the discovery procedure, based on the information about the client 330, which is obtained from the received discovery information.

FIG. 10 is a flowchart illustrating an example of an operation of a host according to an embodiment of the present disclosure.

Referring to FIG. 10, the host may receive a discovery information request from a new host in operation 710.

In operation 720, the host may search for a client that is currently connected to the host itself, and determine the presence of at least one P2P device that cannot be newly connected, among the currently connected clients. If there is at least one P2P device that cannot be newly connected, the host may generate discovery information based thereon. In this case, the discovery information according to the first embodiment of the present disclosure may be generated not to include information about the at least one P2P device that cannot be newly connected. In the case of the second embodiment of the present disclosure, the discovery information may further include information indicating whether the host supports service query for providing detailed state information of the P2P device that cannot be newly connected. Finally, in the case of the third embodiment of the present disclosure, the discovery information may be generated to include not only the information about the at least one device P2P that cannot be newly connected, and its state information, but also the new connectionrelated information of the at least one P2P device that cannot be newly connected. The discovery information according to each embodiment has been described above.

In operation 730, the host may transmit the discovery information generated according to embodiments of the present disclosure, to the new host.

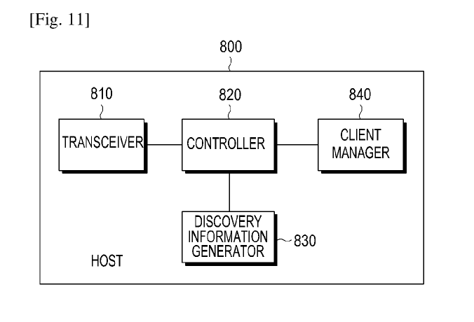

FIG. 11 illustrates an example of a structure of a P2P device according to an embodiment of the present disclosure.

Referring to FIG. 11, the P2P device (or a host 800) may include a transceiver 810, a controller 820, a discovery information generator 830, and a client manager 840.

The transceiver 810 may receive a discovery service request or a service query from a new host, or send a discovery information response or a service response to the new host, according to first to third embodiments of the present disclosure.

The controller 820 may control the client manager 840, to determine whether there is at least one P2P device that cannot be newly connected, among the P2P devices to which the host is currently connected. If there is at least one P2P device, the controller 820 may control the discovery information generator 830 to generate, as in operation 720 of FIG. 10, discovery information based on the information about the at least one P2P device that cannot be newly connected, according to the first to third embodiments of the present disclosure.

The client manager 840, under control of the controller 820, may determine P2P devices to which the host is currently connected, and whether the P2P devices can be newly connected, and provide determination information to the controller 820.

While the disclosure has been shown and described with reference to certain exemplary embodiments thereof, it will be understood by those skilled in the art that various changes in form and details may be made therein without departing from the spirit and scope of the disclosure as defined by the appended claims and their equivalents.

1. A method for discovering a device for Peer-to-Peer (P2P) communication by a first device in a Wireless Fidelity (Wi-Fi) communication system, the method comprising: when receiving a discovery information request from a new device, determining whether there is a second device that cannot be newly connected, among currently connected devices, generating a discovery information response based on the second device if there is the second device, and sending the discovery information response to the new device.

2. The method of claim 1, wherein the discovery information response is generated to exclude information related to the second device.

3. The method of claim 1, wherein the discovery information response is generated to include indication information indicating presence of the second device.

4. The method of claim 3, the method further comprising: receiving a service query from the new device which is received the indication information; and sending information of the second device and information indicating that the second device cannot be currently newly connected, to the new device in response to the service query.

5. The method of claim 4, the method further comprising: determining whether to accept a new-connection request which is received from the new device for connection with the second device; and transmitting according to the determining to accept the new-connection request, to the new device, at least one of information indicating the acceptance of the new-connection request, information indicating an end time of the connection to the second device, and information indicating a waiting time for the new connection.

6. A first device for discovering a device for Peer-to-Peer (P2P) communication in a Wireless Fidelity (Wi-Fi) communication system, the first device comprising: a transceiver configured to receive a discovery information request from a new device; and a controller configured to determine whether there is a second device that cannot be newly connected, among currently connected devices, to generate a discovery information response based on the second device if there is the second device, and to send the discovery information response to the new device.

7. The first device of claim 6, wherein the controller is configured to generate the discovery information response excluding information related to the second device.

8. The first device of claim 6, wherein the controller is configured to generate the discovery information response that includes indication information indicating presence of the second device.

9. The first device of claim 8, the controller is configured to control the transceiver to send a information of the second device and information indicating that the second device cannot be currently newly connected, when recognizing a service query received, wherein the service query is received from the new device which is received the indication information.

10. The first device of claim 9, the controller is configured to determine whether to accept a new-connection request which is received from the new device for connection with the second device, and to control the transceiver to transmit according to the determining to accept the new-connection request, to the new device, at least one of information indicating the acceptance of the new-connection request, information indicating an end time of the connection to the second device, and information indicating a waiting time for the new connection.
